(19) United States
(12) Patent Application Publication
(10) Pub. No.: US 2016/0366123 A1
(43) Pub. Date: Dec. 15, 2016

(54) DEVICE NAMING IN AN INTERNET OF THINGS

(71) Applicant: MCAFEE, INC., Santa Clara, CA (US)

(72) Inventors: Ned M. Smith, Beaverton, OR (US); Nathan Heldt-Sheller, Portland, OR (US); Sven Schrecker, San Marcos, CA (US)

(73) Assignee: MCAFEE, INC., Santa Clara, CA (US)

(21) Appl. No.: 14/865,987

(22) Filed: Sep. 25, 2015

Related U.S. Application Data
(60) Provisional application No. 62/173,882, filed on Jun. 10, 2015.

(51) Int. Cl. H04L 29/06; H04L 29/12

(52) U.S. Cl. CPC H04L 63/0823; H04L 63/062; H04L 61/1511

(57) ABSTRACT

In an example, there is disclosed a computing apparatus, having: a network interface; and one or more logic elements providing a name management engine, operable to: receive a self-assigned name registration request for a name N1 from an endpoint device via the network interface; compare N1 to a database of registered names; determine that the name has not been registered; and sign a certificate for N1. The engine is further operable to determine that the name has been registered, and send a notification that the name is not available. There is also disclosed a computer-readable medium having executable instructions for providing a name management engine, and a method of providing a name management engine.

### CROSS REFERENCE TO RELATED APPLICATIONS

This application claims priority to U.S. Provisional Application 62/173,882, titled “Internet of Things Device Name and Realm Name Selection and Certification,” filed Jun. 10, 2015, which is incorporated herein by reference.

### FIELD OF THE SPECIFICATION

This disclosure relates in general to the field of computer networking, and more particularly, though not exclusively to, a system and method for device naming in an internet of things.

### BACKGROUND

The Internet of Things (IoT) is a loosely-defined network of physical objects (things) with embedded computing and communication capabilities, thus allowing the “things” to exchange data with one another. Within the IoT, real world phenomena can be sensed or observed electronically, and outputs from sensors or other data sources may be used as an input to a control system. In some cases, this allows a tighter coupling between the physical world and the virtual space. Each “thing” in the IoT may be uniquely identified with its physical computing platform, and some things are configured to operate within the existing internet infrastructure. Other devices operate over other network topologies, including ad hoc networks and direct data connections among others. In general terms, the IoT is considered to be highly-democratic (sometimes even anarchic) in that individual devices and networks may have broad autonomy in terms of what they do, how they do it, and how they communicate about it.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of a monitored network, which may be or comprise an IoT realm or domain, according to one or more examples of the present specification.

FIG. 2 is a block diagram of a data source according to one or more examples of the present specification.

FIG. 3 is a block diagram of a data aggregator according to one or more examples of the present specification.

FIG. 4 is a block diagram of an expert system according to one or more examples of the present specification.

FIG. 5 is a block diagram of naming architecture according to one or more examples of the present specification.

FIG. 6 is a flow chart of a name registration method according to one or more examples of the present specification.

FIG. 7 is a flow chart of a name revocation method according to one or more examples of the present specification.

FIG. 8 is a flow chart of a method of establishing a secured channel between two realms according to one or more examples of the present specification.

FIG. 9 is a block diagram of a key management server according to one or more examples of the present specification.

FIG. 10 is a block diagram of a naming authority according to one or more examples of the present specification.

FIG. 11 is a block diagram of a trusted execution environment according to one or more examples of the present specification.

### SUMMARY

In an example, there is disclosed a computing apparatus, having: a network interface; and one or more logic elements providing a name management engine, operable to: receive a self-assigned name registration request from a name, N1, from an endpoint device via the network interface; compare N1 to a database of registered names; determine that the name has not been registered; and sign a certificate for N1. The engine is further operable to determine that the name has been registered, and send a notification that the name is not available. There is also disclosed a computer-readable medium having executable instructions for providing a name management engine, and a method of providing a name management engine

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purposes of simplicity and clarity and does not in itself dictate a relationship between the various embodiments and/or configurations discussed. Different embodiments may have different advantages, and no particular advantage is necessarily required of any embodiment.

The “Internet of Things” (IoT) is an explosive global aggregation of heterogeneous “smart” and “network-enabled” devices that often each provide a single, specialized function. The IoT includes smart appliances, smart sensors, smart phones, and a plethora of other devices to which “smart” can be (and often is) prepended.

Because the IoT is not a traditional network, it presents challenges that are sometimes new and unique. For example, in traditional networking, an oligarchy of naming authorities parcel out a relative handful of globally-unique internet protocol (IP) addresses, as in the IPv4 space, which has a theoretical maximum of approximately 4.3 billion unique addresses. This made global IPv4 addresses a relatively clear commodity to be managed centrally by an administrative body. But the cascade of IoT devices makes such a scheme both impractical and undesirable for many. Rather, IoT devices may operate within defined subnetworks using network address translation (NAT), or may self-declare a “Universally Unique Identifier” (UUID), which in one example is a 128-bit integer, and which may be usable as an IPv6 IP address. Such autonomous naming presents both new opportunities and new challenges that users and enterprises are still working to understand and appreciate. In one sense, the IoT may be viewed as a new, wild frontier, where rules are still evolving and where any device can be practically anything that it wants to be. While this provides exciting opportunities for innovators to experiment and try new things, it also provides a sometimes-lawless frontier where devices and their designers may not always be able to rely on traditional security solutions.

By some estimates, 20-50 billion IoT devices will be deployed in the world by 2020. For these devices to be able to interoperate without conflict, each device may need a name or identifier that does not conflict with other names already in use. IoT devices may also be grouped or may cooperate with other devices in a context (e.g., a “realm”) where the context or realm has its own name or identifier. In many cases, IoT networks are a conglomerate of disparate proprietary networks and transport layer technologies that do not agree on a single common network-naming scheme. So it is unlikely that all device names will neatly map to an IPv6 namespace (128-bit identifier). Thus, the existing internet naming infrastructure may fall short in handling some IoT device names.

An alternative approach allows devices to self-assert a name such as a UUID where the UUID algorithm produces a pseudo-unique UUID. In this case, pseudo-unique simply means that a self-asserted name (such as an IPv6 UUID) need not be parceled out as a finite, controlled resource the way 32-bit IPv4 addresses are currently handled. Rather, the device may choose its own name, and trust within a statistical probability that the name will be unique. For example, on a simple level, with a 128-bit address space, there is room for 3.4×10³⁸ unique addresses. Thus, the instantaneous probability of a truly random algorithm selecting the same address twice is 1 in 3.4×10³⁸, which is beyond astronomical improbability. However, this result is skewed. Several factors complicate the probability, such as the large number of devices choosing names, and the fact that an IPv6 address includes structured fields rather than being simply a random 128-bit number. Some formal probability analyses have been published to evaluate the actual probability of IPv6 name collisions. And in short, the statistical likelihood that randomly-chosen, self-asserted UUID is genuinely unique is high enough that it is reasonable to permit devices to self-assert a name, and then provide mechanisms to deal with naming collisions if they occur.

Nevertheless, self-asserted names may not be deemed authoritative except within the user's or organization's administrative domain. So even when a UUID is self-asserted, it may not be known whether the entity assigning the name is authorized, or if a rogue entity is engaged in a so-called “Sybil attack,” in which a rogue actor seeks to subvert a peer-to-peer network with a forged identity.

Organizations deploying IoT networks may find it helpful to group collections of devices in such a way that the collection itself (e.g., a “realm” or “domain”) should be given a name. As with individual devices, there may be a collision in self-asserted realm names. Thus, it is recognized herein that there is a need for a method to name devices and collections of devices that deals with issues of collision, authenticity, and Sybil or similar attacks.

An IoT network may also require assignment of cryptographic keys to devices so that device interactions can be protected. Key management services such as draft-hardjono-ace-fluffy-00 consider use of an IoT device that generates and assigns symmetric keys to peer devices following a Needham-Schroeder method. But at least some embodiments of those methods do not consider how a device name is reliably and securely associated to the device. They may also presume that the key management server has knowledge of the expected device name and method for authenticating the device to the key management server. But the key management server may need to negotiate with other key management servers to determine device collection names that do not conflict and are not subject to Sybil attacks.

Embodiments of the methods disclosed in this specification provide device and device group (a.k.a. realm) naming and assertion. The names may become authoritative names for IoT networks by combining a variety of Internet naming and certification technologies with IoT device and group naming conventions. This specification also provides methods for privacy protections in light of the intended objective of assigning unique identifiers to devices and collections.

In an example, a naming authority (NA) supports a device or localized key management server that selects (asserts) a name to the NA, which establishes whether the name is already assigned to a different entity. The NA provides a certification (certificate) indicating simply that the name has not been previously assigned. Name assignment services may also support a business model where assigned names are rented or purchased as a way to pay for the cost of operating the NA. This specification also provides a method for efficiently determining if a name is previously assigned and resolving race conditions associated with name issuance.

Once a name is issued, it is anticipated that other devices and key management servers may seek to verify whether or not the name is currently “in use,” and if so, which authoritative entity is making the claim. A modified domain name system (DNS) infrastructure may be used according to RFC6698 where a certificate (subjectPublicKey) may be used by a DNS service to lookup a subjectAltName. This lookup allows the verifier to quickly establish that a device name or realm name has been reserved by a trusted NA and that another entity is not able to assert the same name. This may help to prevent Sybil attacks, for example.

This specification also provides for a key management server (KMS), wherein a first KMS1 may engage with a second KMS2. In an example, each KMS reserves a name using the NA and each dynamically asserts ownership of its respective name using a Diffie-Hellman key agreement protocol. If the certificate that is issued to KMS1 or KMS2 is used to sign the DH exchange, a MITM attacker is unable to disguise itself as either KMS1 or KMS2. So a secure channel can be established between KMS1 and KMS2, and there is no ambiguity over which name either KMS asserts as its own. This allows secure ad-hoc introduction of an IoT network (aka collection of devices) within a second IoT network with the knowledge that a third suspicious party cannot monitor the exchange or pose as KMS1 or KMS2.

Each KMS may obtain a realm name that is unique following a similar method as previously described, wherein the realm name is again unique (unused by another realm), and where the KMS asserts the realm name when issuing KMS “mini-tickets” to devices within a realm. A second KMS2 is unable to issue a mini-ticket with the same name because the KMS realm name may be independently verified using the NA certificate and a proof-of-possession block that accompanies mini-ticket issuance.

In situations where privacy may be a concern (e.g., where there is danger that a device may be tracked based on its use of the identifier, knowing that the identifier is not used by any other device), a device may exhibit a privacy protection strategy by frequently changing its device identity.

A separate (non-NA) service called a name revocation authority (NRA) may process identity revocations. This avoids the prospect that an NA may correlate requests for new identities with requests to revoke identities. The NRA accepts revocation requests from a large community of NA issued names and constructs a certificate revocation list (CRL), which in an example contains a minimum number of CRL entries (e.g. millions or more). The CRL is submitted to the NA en masse, preventing the NA from easily correlating subsequent NA certificate requests with a particular CRL entry. Unlike some existing CRL processing methods, the NRA accepts the revocation request on condition of a proof-of-possession. In other words, CRLs are only processed by the entity to which the name was assigned. If desired, the CRL may be post-dated so that the revocation occurs at a time chosen by the revoking entity, and in one example CRL submissions may be made through a “Tor” anonymizing network to further confuse potential correlation activity.

In an example, a DNS-based Authentication of Named Entities (DANE) service may be provided to efficiently find a previously allocated device or IoT realm name.

In certain embodiments, a naming authority (NA) may singularly assign a name value to an asymmetric key.

Also in an example, a trusted execution environment (TEE) may be used to protect an asymmetric key and to establish TEE properties that implement non-repudiation hardening.

Advantageously, use of a name revocation authority (NRA) protects privacy of the entity performing the revocation request by batching CRL entries in a very large CRL, and where the CRL requestor may be obfuscated by a Tor network. The CRL requestor may prove possession of the private key as a condition of revocation to prevent unauthorized revocations of the assigned name. Thus, the owner of an assigned name may obtain a different name frequently to protect privacy.

In some embodiments, a KMS may dynamically assign symmetric keys to IoT devices according to a Needham-Schroeder (or similar) protocol where an NA issued name is a device name and where a second NA issued name is a realm name.

A system and method for device naming in an internet of things will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

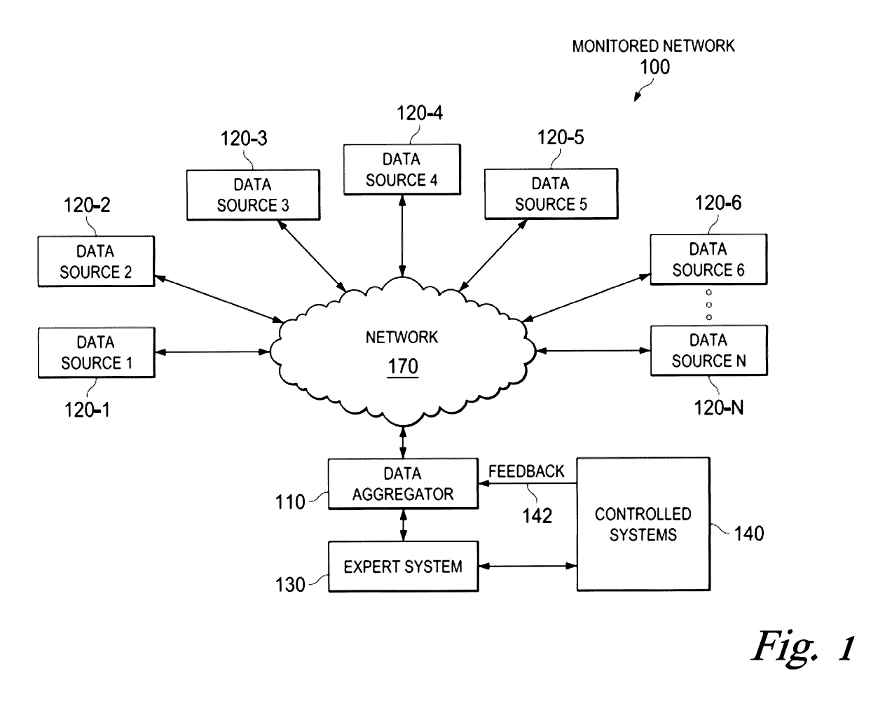

FIG. 1 is a network level diagram of a monitored network 100 according to one or more examples of the present specification. This figure illustrates a useful structure and application for an Internet of Things (IoT), though this embodiment should be understood to be nonlimiting. Monitored network 100 illustrates an example application in which the IoT provides inputs from a plurality of data sources, which are aggregated by a data aggregator. An expert system may then make decisions to drive a controlled system.

In this example, monitored network 100 includes a plurality of data sources 120 connected to a network 170. Also connected to network 170 is a data aggregator 110, communicatively coupled to an expert system 130, controlling controlled systems 140. Controlled systems 140 provide feedback 142 to data aggregator 110.

In one or more examples, data sources 120-1 through 120-N are disclosed. This is to illustrate that the number of data sources 120 may be large and indefinite, and may be in constant fluctuation as new data sources 120 are added to and removed from monitored network 100. Management of data sources 120 may be complicated both by the large number of data sources 120, and by the dynamic nature of monitored network 100. Thus in certain embodiments, it may be impractical for a human administrator to monitor and administer all of the various data sources 120. Furthermore, data sources 120 may not be statically located on network 170. For example, many cars carry data collection devices, and may provide data to network 170 as they hop from node to node on a mobile network. Thus, it may not be practical to predict in advance from which direction data will be coming, or what the nature of the data may be.

By way of further complication, a plurality of data sources 120 may provide data features of similar or identical types, but in slightly different formats. In one example, each data source 120 is configured to provide a data stream accompanied by a metadata packet identifying the type and source of data. However, there may be no globally enforced or enforceable standard for such metadata packets. In an example, data sources 120 may at least standardize on a delivery format for the metadata, such as XML or a similar standards-compliant data format. In that case, the metadata may have a number of identifiable field names, from which the feature type and source may be inferred. It should also be noted that in some cases data sources 120 may provide features of a compatible type, but in different formats. An example of this is a temperature feature provided by one data source 120-1 in Fahrenheit, and a second feature provided by a second data source 120-2 in Celsius. Similar issues may be encountered in any case where two or more data sources deliver similar features, with one data source providing the feature in metric units and the other data source providing the feature in Imperial or U.S. Customary units.

This large collection of features of disparate types from different sources, and in different formats, is delivered via network 170 to a data aggregator 110. Data aggregator 110 collects the many features, and in an example attempts to classify the features according to a useful taxonomy. In one case, data aggregator 110 defines a taxonomy having an arbitrary number of classification levels, such as classes, sub-classes, genera, and species. For example, the class of environmental data may include the subclass of temperature, which may include further species of temperatures by location or source. In one example, all environmental features are classified as environmental features, temperature features are classified as temperature features, and temperature features of a common species may be aggregated by data aggregator 110 as being species that may be usefully combined. Data aggregator 110 may then provide one or more outputs to expert system 130.

Expert system 130 may include one or more devices operable to collect features and to control one or more controlled systems 140. Expert system 130 may make decisions based on lookup tables, computer models, algorithms, or machine learning techniques. Features provided by data aggregator 110 may provide key inputs into the decisions that expert system 130 must make.

Controlled systems 140 may include a number of real-world systems, such as air-conditioning, environmental systems, security systems, traffic systems, space-based systems, and any other system subject to automated control or data-driven operation. Controlled system 140 may include, in certain embodiments, facilities to measure the response of controlled systems 140 to inputs from expert system 130. Controlled systems 140 may then provide feedback 142 to data aggregator 110. This may allow data aggregator 110 to measure the effect of combining or cross correlating certain features. In cases where data aggregator 110 determines that combining or cross correlating certain features has minimal impact on controlled systems 140, or in some cases even negative impact on controlled systems 140, data aggregator 110 may elect to unmerge certain features that are not found to be usefully combined.

In an example, each data source 120 may include an appropriate operating system, such as Microsoft Windows, Linux, Android, Mac OSX, Apple iOS, Unix, or similar. Some of the foregoing may be more often used on one type of device than another. For example, desktop computers or engineering workstation may be more likely to use one of Microsoft Windows, Linux, Unix, or Mac OSX. Laptop computers, which are usually a portable off-the-shelf device with fewer customization options, may be more likely to run Microsoft Windows or Mac OSX. Mobile devices may be more likely to run Android or iOS. Embedded devices and dedicated appliances may run real-time operating systems such as real-time Linux, QNX, VxWorks, or FreeRTOS. For embedded devices without real-time demands, minimal Linux-based operating systems are currently very popular. However, all of the foregoing examples are intended to be nonlimiting.

Network 170 may be any suitable network or combination of one or more networks operating on one or more suitable networking protocols, including for example, a local area network, an intranet, a virtual network, a wide area network, a wireless network, a cellular network, Bluetooth connections, or the Internet (optionally accessed via a proxy, virtual machine, or other similar security mechanism) by way of nonlimiting example. Importantly, network 170 need not be an IP-based network, but is broadly intended to encompass any suitable interconnect that allows devices to communicate with one another. This could include direct serial or parallel connections, Bluetooth, infrared communications, packet radio, telephony, or any other suitable communication link.

Certain functions may also be provided on one or more servers, or one or more “microclouds” in one or more hypervisors. For example, a virtualization environment such as vCenter may provide the ability to define a plurality of “tenants,” with each tenant being functionally separate from each other tenant, and each tenant operating as a single-purpose microcloud. Each microcloud may serve a distinctive function, and may include a plurality of virtual machines (VMs) of many different flavors, including agentful and agentless VMs.

In certain examples, monitored network 100 (or suitable portions thereof) may form an IoT “realm” or “domain,” or may be part of a larger realm or domain.

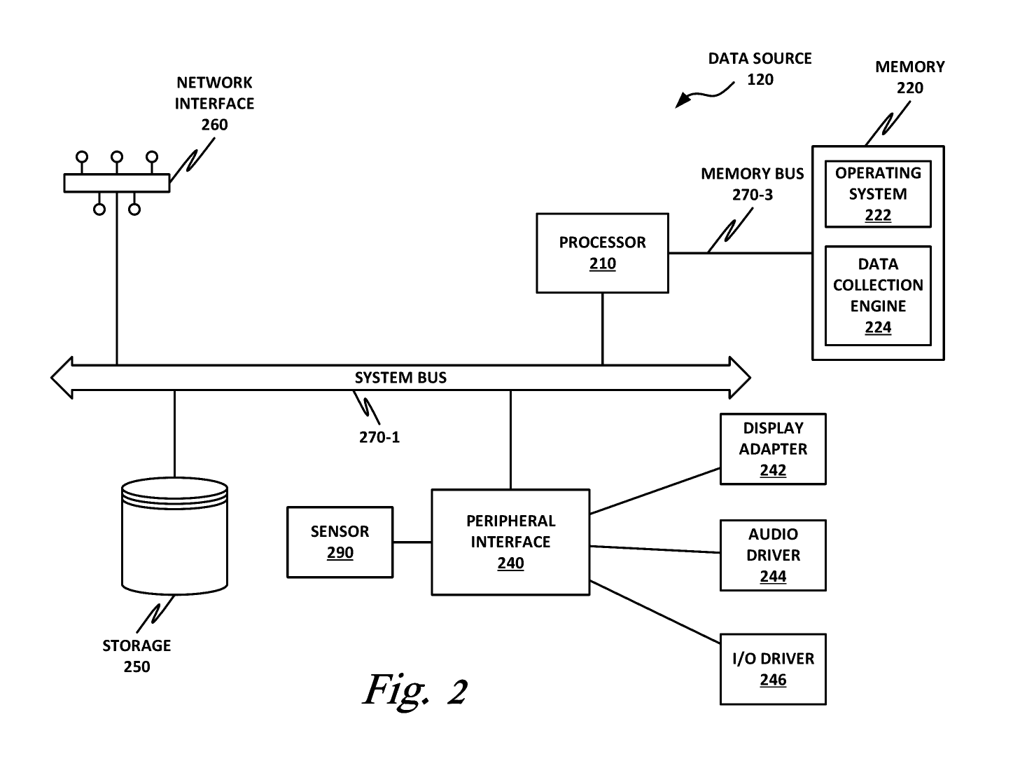

FIG. 2 is a block diagram of a data source according to one or more examples of the present specification. Data source 120 may be any suitable computing device. In various embodiments, a “computing device” may be or comprise, by way of non-limiting example, a computer, workstation, server, mainframe, virtual machine (whether emulated or on a “bare-metal” hypervisor), embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data. Any computing device may be designated as a host on the network. Each computing device may refer to itself as a “local host,” while any computing device external to it may be designated as a “remote host.”

Data source 120 includes a processor 210 connected to a memory 220, having stored therein executable instructions for providing an operating system 222 and at least software portions of a data collection engine 224. Other components of data source 120 include a storage 250, network interface 260, and peripheral interface 240. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 210 is communicatively coupled to memory 220 via memory bus 270-3, which may be, for example, a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 210 may be treated as only one core of a multi-core processor, or may be treated as the entire multi-core processor, as appropriate. In some embodiments, one or more co-processors may also be provided for specialized or support functions.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this specification, and that other memory architectures are available.

Storage 250 may be any species of memory 220, or may be a separate device. Storage 250 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of data collection engine 224. Many other configurations are also possible, and are intended to be encompassed within the broad scope of this specification.

Network interface 260 may be provided to communicatively couple data source 120 to a wired or wireless network. A “network,” as used throughout this specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, direct parallel or serial connection, packet radio, or any other appropriate architecture or system that facilitates communications in a network or telephonic environment.

Data collection engine 224, in one example, is operable to carry out computer-implemented methods as described in this specification. Data collection engine 224 may include one or more tangible non-transitory computer-readable mediums having stored thereon executable instructions operable to instruct a processor to provide a data collection engine 224. As used throughout this specification, an “engine” includes any combination of one or more logic elements, of similar or dissimilar species, operable for and configured to perform one or more methods provided by the engine. Thus, data collection engine 224 may comprise one or more logic elements configured to provide methods as disclosed in this specification. In some cases, data collection engine 224 may include a special integrated circuit designed to carry out a method or a part thereof, and may also include software instructions operable to instruct a processor to perform the method. In some cases, data collection engine 224 may run as a “daemon” process. A “daemon” may include any program or series of executable instructions, whether implemented in hardware, software, firmware, or any combination thereof, that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space,” or in ring 0, 1, or 2 in a protection ring architecture. It should also be noted that data collection engine 224 may also include other hardware and software, including configuration files, registry entries, and interactive or user-mode software by way of non-limiting example.

In one example, data collection engine 224 includes executable instructions stored on a non-transitory medium operable to perform a method according to this specification. At an appropriate time, such as upon booting data source 120 or upon a command from operating system 222 or a user 120, processor 210 may retrieve a copy of the instructions from storage 250 and load it into memory 220. Processor 210 may then iteratively execute the instructions of data collection engine 224 to provide the desired method.

Peripheral interface 240 may be configured to interface with any auxiliary device that connects to data source 120 but that is not necessarily a part of the core architecture of data source 120. A peripheral may be operable to provide extended functionality to data source 120, and may or may not be wholly dependent on data source 120. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage by way of non-limiting example.

In one example, peripherals include display adapter 242, audio driver 244, and input/output (I/O) driver 246. Display adapter 242 may be configured to provide a human-readable visual output, such as a command-line interface (CLI) or graphical desktop such as Microsoft Windows, Apple OSX desktop, or a Unix/Linux X Window System-based desktop. Display adapter 242 may provide output in any suitable format, such as a coaxial output, composite video, component video, VGA, or digital outputs such as DVI or HDMI, by way of nonlimiting example. In some examples, display adapter 242 may include a hardware graphics card, which may have its own memory and its own graphics processing unit (GPU). Audio driver 244 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of non-limiting example.

In an example, peripherals include one or more sensors 290, which may be configured and operable to collect data about real-world phenomena and to process the data into a digital form. In one operative example, data collection engine 224 collects data from sensor 290 via peripheral interface 240. The collected data may then be stored in storage 250 and/or sent over network interface 260.

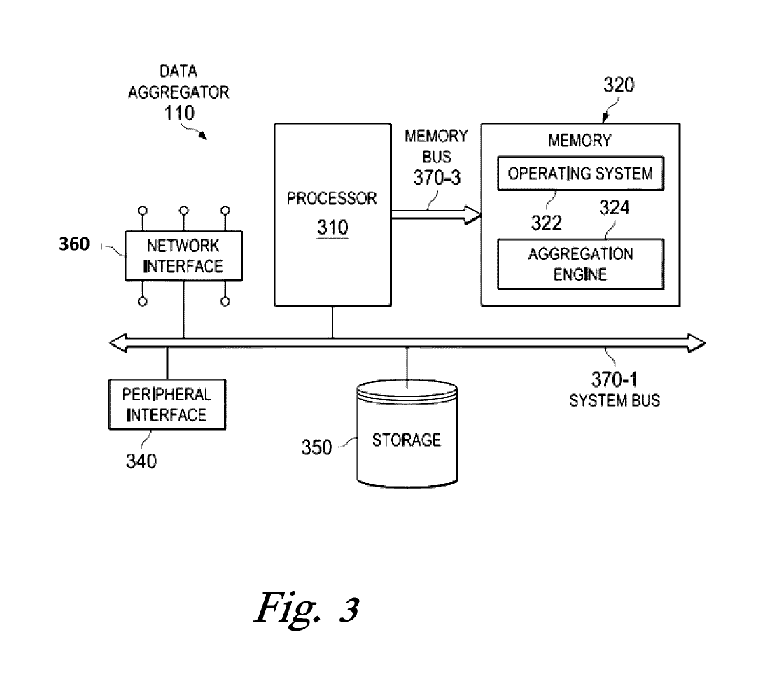

FIG. 3 is a block diagram of a data aggregator 110 according to one or more examples of the present specification. Data aggregator 110 may be any suitable computing device, as described in connection with FIG. 2. In general, the definitions and examples of FIG. 2 may be considered as equally applicable to FIG. 3, unless specifically stated otherwise.

Data aggregator 110 includes a processor 310 connected to a memory 320, having stored therein executable instructions for providing an operating system 322 and at least software portions of a aggregation engine 324. Other components of data aggregator 110 include a storage 350, network interface 360, and peripheral interface 340. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of aggregation engine 324.

Network interface 360 may be provided to communicatively couple server 140 to a wired or wireless network, and may include one or more logic elements as described in FIG. 2.

Aggregation engine 324 is an engine as described in FIG. 2 and, in one example, includes one or more logic elements operable to carry out computer-implemented methods as described in this specification. Software portions of aggregation engine 324 may run as a daemon process.

Aggregation engine 324 may include one or more non-transitory computer-readable mediums having stored thereon executable instructions operable to instruct a processor to provide a security engine. At an appropriate time, such as upon booting server 140 or upon a command from operating system 322 or a user or security administrator, processor 310 may retrieve a copy of aggregation engine 324 (or software portions thereof) from storage 350 and load it into memory 320. Processor 310 may then iteratively execute the instructions of aggregation engine 324 to provide the desired method. Operationally, aggregation engine 324 may be configured to collect and classify data provided by data sources 120.

Peripheral interface 340 may be configured to interface with any auxiliary device that connects to data aggregator 110 but that is not necessarily a part of the core architecture of data aggregator 110. Peripherals may include, by way of non-limiting examples, any of the peripherals disclosed in FIG. 2. In some cases, data aggregator 110 may include fewer peripherals than data source 120, reflecting that it may be more focused on providing processing services rather than interfacing directly with users.

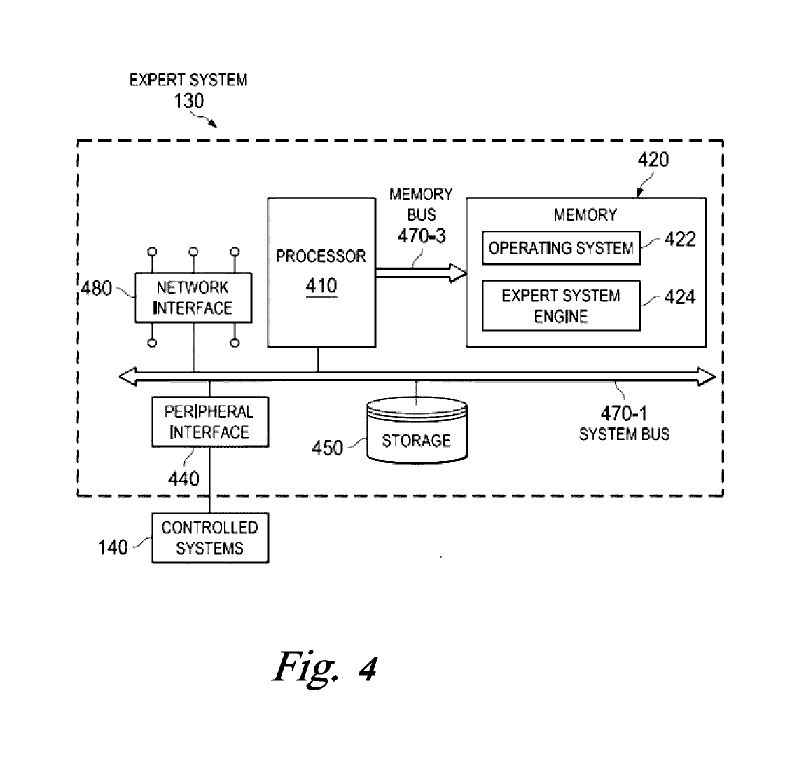

FIG. 4 is a block diagram of an expert system 130 according to one or more examples of the present specification. Expert system 130 may be any suitable computing device, as described in connection with FIG. 2. In general, the definitions and examples of FIG. 2 may be considered as equally applicable to FIG. 4, unless specifically stated otherwise.

Expert system 130 includes a processor 410 connected to a memory 420, having stored therein executable instructions for providing an operating system 422 and at least software portions of a expert system engine 424. Other components of expert system 130 include a storage 450, network interface 480, and peripheral interface 440. As described in FIG. 2, each logical block may be provided by one or more similar or dissimilar logic elements.

In an example, processor 410 is communicatively coupled to memory 420 via memory bus 470-3, which may be for example a direct memory access (DMA) bus. Processor 410 may be communicatively coupled to other devices via a system bus 470-1.

Processor 410 may be connected to memory 420 in a DMA configuration via DMA bus 470-3, or via any other suitable memory configuration. As discussed in FIG. 2, memory 420 may include one or more logic elements of any suitable type.

Storage 450 may be any species of memory 420, or may be a separate device, as described in connection with storage 250 of FIG. 2. Storage 450 may be, or may include therein, a database or databases or data stored in other configurations, and may include a stored copy of operational software such as operating system 422 and software portions of expert system engine 424.

Network interface 460 may be provided to communicatively couple controlled systems 140 to a wired or wireless network, and may include one or more logic elements as described in FIG. 2.

Expert system engine 424 is an engine as described in FIG. 2 and, in one example, includes one or more logic elements operable to carry out computer-implemented methods as described in this specification. Software portions of expert system engine 424 may run as a daemon process.

Expert system engine 424 may include one or more non-transitory computer-readable mediums having stored thereon executable instructions operable to instruct a processor to provide a security engine. At an appropriate time, such as upon booting controlled systems 140 or upon a command from operating system 422 or a user or security administrator, processor 410 may retrieve a copy of expert system engine 424 (or software portions thereof) from storage 450 and load it into memory 420. Processor 410 may then iteratively execute the instructions of expert system engine 424 to provide the desired method. Operationally, expert system engine 424 may be configured to receive aggregated data from data aggregator 110 and to make decisions about how to control controlled system 140.

Peripheral interface 440 may be configured to interface with any auxiliary device that connects to expert system 130 but that is not necessarily a part of the core architecture of expert system 130. Peripherals may include, by way of non-limiting examples, any of the peripherals disclosed in FIG. 2. In some cases, expert system 130 may include fewer peripherals than data source 120, reflecting that it may be more focused on providing processing services rather than interfacing directly with users.

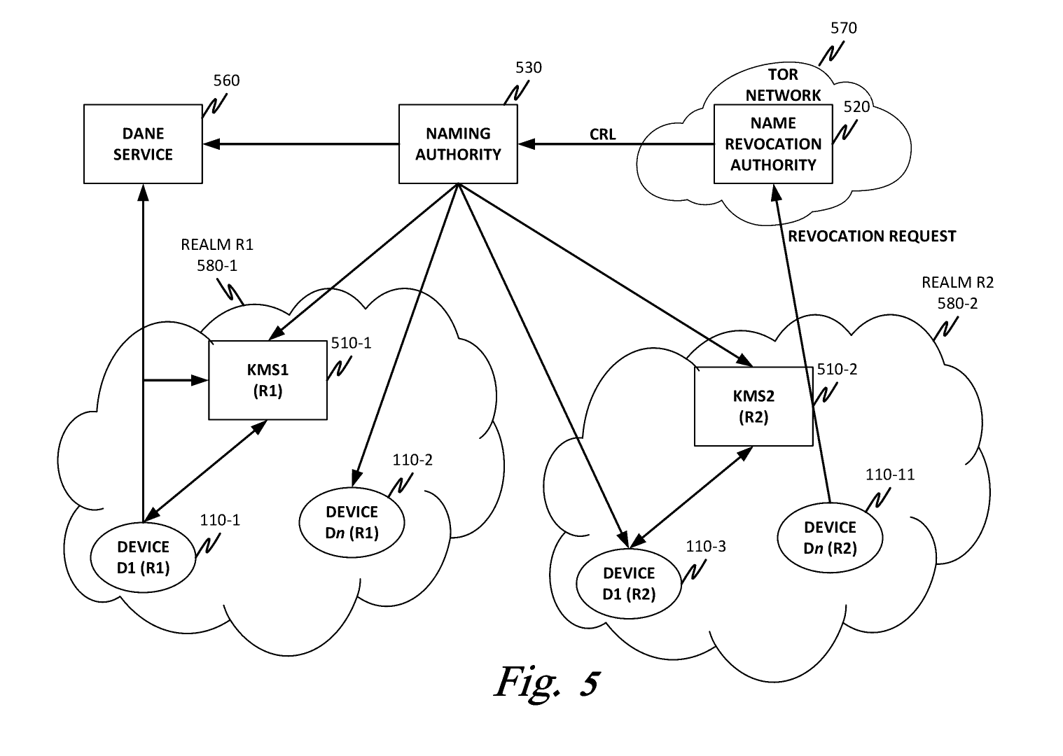

FIG. 5 is a block diagram of a naming scheme for an IoT architecture. This embodiment includes three services for managing IoT device names and IoT realm names. These services should be understood to be logical functions, and need not be provided on separate physical or virtual machines. Rather, they represent logical functional divisions that may be implemented on any suitable combination of logic elements.

In this example, DANE service 560 handles name requests using an issued certificate subject public key or using the issued name. DANE is a protocol that allows X.509 certificates, commonly used for Transport Layer Security (TLS), to be bound to DNS names using Domain Name System Security Extensions (DNSSEC). X.509 is disclosed as a nonlimiting example. In other cases, other formats may be for signing documents, such as JSON Web Signature (JWS), or any other suitable format. In an example, the lookup request may return information about the device or realm including network addresses or other device or host attributes. A lookup request may also be signed by DANE service 560 to authenticate the lookup results.

Naming authority (NA) 530 issues certificates corresponding to device and realm name issue requests, where the objective is to establish that no other entity has been issued the same name. NA 530 may operate on a database of names where a database locking scheme such as a hierarchical lock manager and a hash table index may be used to quickly identify the name entry and prevent duplicate assignment due to race conditions. The name database may be replicated for high-availability and resistance to denial-of-service attacks. A distributed lock manager may be used to ensure replicated shares do not result in duplicate name issuance.

Name revocation authority (NRA) 520 issues CRLs that revoke issued names in a privacy-protecting manner to prevent unauthorized tracking of devices and realm activity using an issued name. In an example, the CRL contains a large number of name revocation requests so that a correlation between revocation requests and new name issuances is impractical.

In an embodiment, a name revocation request may protect the requestor by routing the request through a Tor network 570 to obfuscate the requester's identity. The revocation request may further be obfuscated by post-dating when the request may be processed. The NRA prevents unauthorized name revocations (which may allow to denial of service) by verifying the requestor has high certification veracity consisting of a TEE that protects the private key.

Devices 110 (which may be IoT data sources) and key management servers (KMS) 510 may request device and realm names from the NA according to their need.

Realm R1 580-1 includes a plurality of devices D1 110-1-Dn 110-2. R1 580-1 also includes KMS1 510-1, which in some cases may act as a local naming authority for R1 580-1.

Realm R2 580-2 includes a plurality of devices D1 110-3-Dn 110-n. R2 580-2 also includes KMS2 510-2, which in some cases may act as a local naming authority for R2 580-2.

In an embodiment, names are self-assigned and asserted by devices 110 or by KMS 510, and are certified by NA 530. However, in other embodiments, names can be assigned by NA 530. Certified names are unique (not used by another entity), thus mitigating Sybil-type attacks.

Peer KMS entities (e.g., KMS 510-1 and KMS 510-2) may establish an ad-hoc trust relationship by negotiating a Diffie-Hellman (DH) key exchange where the NA-issued certificate is used to sign the DH exchange. This establishes that the KMS entities are not spoofed by a rogue MITM and establishes realm namespaces that are distinct such that a device D1 110-1 (called D1R1 here) with a name not assigned by NA 530 can be disclosed to a second realm R2 having a device with the same name D1 110-3 (called D1R2 here). D1R1 110-1 is distinguishable from the D1R2 110-3 because they are in separate realms, even though each may use the name “D1” internally. KMS entities may issue mini-tickets that provision symmetric keys for end-to-end device interactions dynamically. Use of the naming services allows cross-realm key management without confusion regarding misdirected symmetric keys.

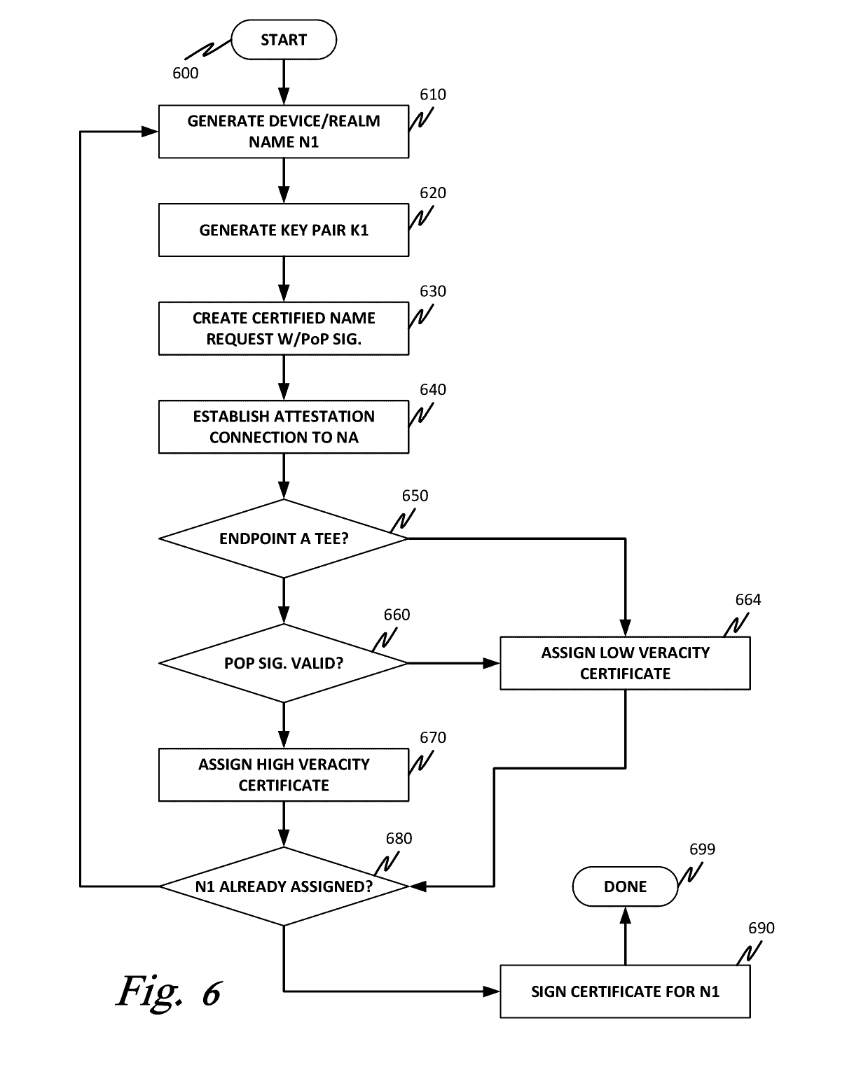

FIG. 6 is a flow chart of name assignment method 600 according to one or more examples of the present specification. In an embodiment, name assignments follow a process similar to a PKCS10 certificate signing request, but in this case the certificate proves that the requested name has not been claimed by another device or realm. It also may establish that the requester has a sufficiently hardened environment, such as a TEE. This may help to prevent a “confused deputy” style, particularly where key non-repudiation properties are in force. An attestation protocol such as Intel Sigma, SigmaCE, or TPM attestation may be used to establish trust properties. The certificate may reflect the ability of the client device's environment to protect the key and perform other security and privacy related operations. NA 530 may further implement a method of payment for issued names where the name is rented or purchased for a period of time and where issuance is conditional on payment of agreed remuneration.

In block 610, a device 110 or KMS 510 may self-assign a device or realm name, N1.

In block 620, KMS 510 generates an appropriate key pair K1, which may be used to attest name N1.

In block 630, KMS 510 may generate a certified name request, optionally with a proof of possession (PoP) private key.

In block 640, KMS 510 establishes an attestation connection to NA 530.

In decision block 650, NA 530 checks whether the endpoint (device or KMS) has a verified TEE. If there is no verified TEE, then in block 664, a “low veracity” certificate may be assigned. This means that the name is certified, but the device has a lower trust level because it has not provided hardened security features.

In block 660, if there is a TEE, then NA 530 checks whether the PoP signature is valid. If it is not, then again, in block 664, NA 530 assigns a low veracity certificate to the endpoint.

If the PoP signature is valid, then in block 670, NA 530 assigns the endpoint a high veracity certificate. This certificate indicates that the name is certified, and the device has a relatively high degree of trust.

In block 680, NA 530 checks whether the proposed name has already been assigned to some other device. Optionally, this may include determining whether the name has been revoked on a CRL. In other embodiments, the name space is large enough that it is reasonable to enforce universal uniqueness.

If the name has already been used, then NA 530 may send a signal informing the endpoint device that the name is not available. The device may still choose to use the name, but the name will not be certified and trusted.

If the name has not already been used, then in block 690, NA 530 signs the certificate for N1. The endpoint device (realm 580 or device 110) may then use the name as a trusted, certified name.

In block 699, the method is done.

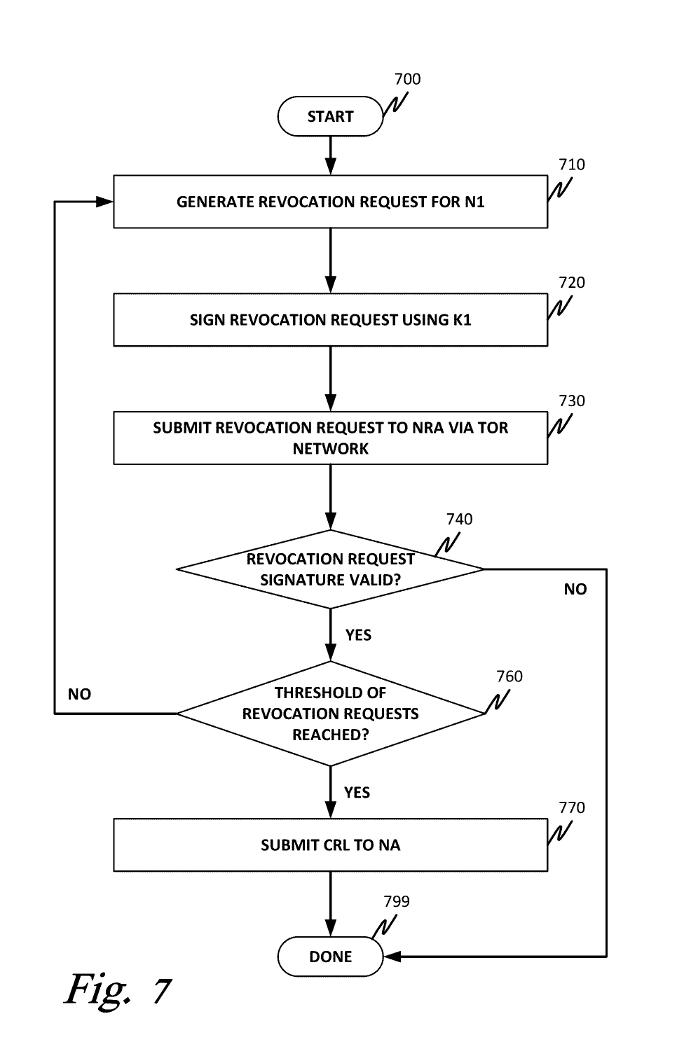

FIG. 7 is a flow chart of name revocation method 700 according to one or more examples of the present specification. It should be noted that the method of FIG. 7 could be performed on NA 530, on NRA 520, or on any other suitable device. A strict separation of NRA 520 from NA 530 is disclosed herein by way of nonlimiting example, with an illustration of enhanced security that is realized by separating the functions. NRA 520 may aggregate and batch CRLs so that it is difficult or impossible to trace a specific CRL to a specific actor at a specific time. This can enhance security and privacy.

Absent a separate NRA or some other method to anonymize the CRL, it may be possible for unauthorized entities to use NA issued names to track a device or realm knowing that no other device or realm is using the same name. This has privacy implications. A strategy for minimizing negative privacy implications is to limit the use of the key. This is achieved by revoking the name using a CRL issued independently by NRA 520. In an embodiment, NRA 520 is separate and independent from NA 530.

NRA 520 helps to ensure that revocation requests are not correlated with a name issuance event. This is achieved by NRA 520 forming a large CRL batch (for example, in the millions) so that correlation of name issuance events and name revocation events is impractical. The NRA may establish a business model where use of the service to revoke is subject to a fee. Having a separate business justification for NRA 520 and NA 530 helps prevent collusion between the separate entities that may result in loss of privacy.

Revocation requests may be further protected by submitting requests through a Tor network, where the submission event may not be traced to a particular device or host and to a particular time of day. The request itself may include post-dated revocation to further disassociate the revocation event from a name issuance event.

The endpoint device (e.g., device 110 or realm 580) may sign the request to allow the NRA to validate PoP of the private key, further establishing authorization to revoke. This helps prevent rogue entities from performing denial of service attack on the name.

A condition of revocation may be to inform other devices of the revocation, including for example a peer KMS2 where KMS1 may have issued symmetric key tickets or established other context based on the name. This ensures that if re-issuance occurs, it does not represent a threat to the previous owner of the name.

A condition of revocation may also be that a revoked name may not be reused or may not be reused for a period of time determined to be safe by the previous owner or the NRA.

In block 710, an endpoint device generates a name revocation request for name N1.

In block 720, the endpoint device signs the name revocation request using key K1.

In block 730, the endpoint device submits the name revocation request to NRA 520, for example via Tor network 570.

In decision block 740, NRA 520 checks whether the signature on the revocation request is valid. If it is not, then the name is not added to the CRL, and in block 799, the method is done.

If the signature on the name revocation request is valid, then in decision block 760, NRA 520 checks whether it has reached its threshold of revocations before submitting the CRL. As discussed above, this may be a large number, for example in the millions, to help prevent easy correlation between revocations and issuance of new names. If the threshold has not been reached, then NRA 520 continues to wait for additional name revocation requests.

If the threshold has been reached, then in block 770, NRA 520 submits the CRL to NA 530.

In block 799, the method is done.

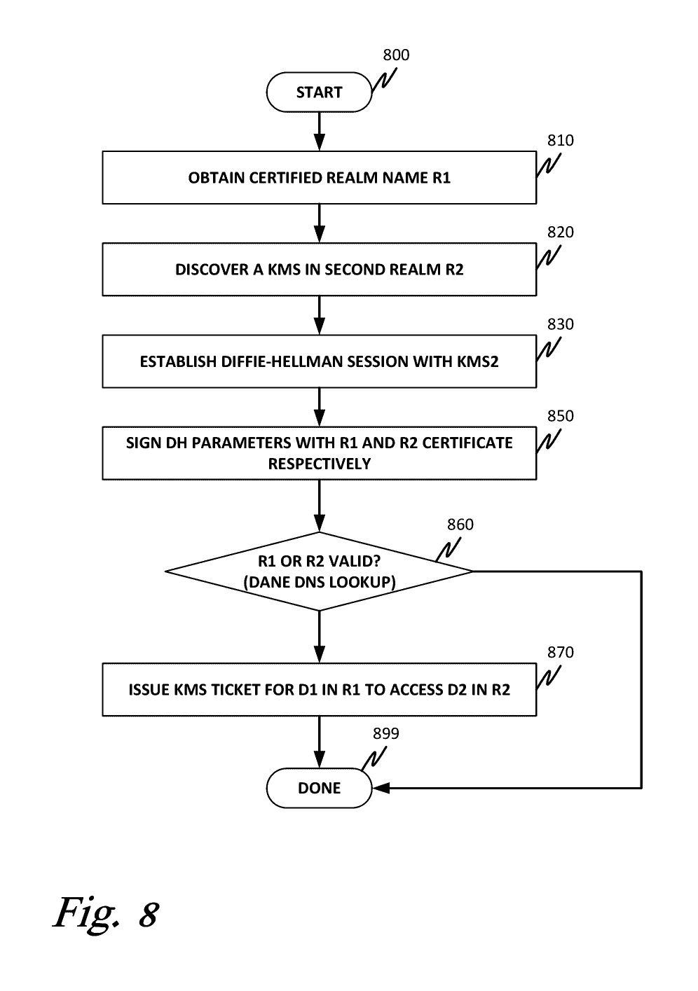

FIG. 8 is a flow chart of a method 800 for realm naming. This method may be particularly suited to preventing Sybil-type attacks. This may have value for IoT deployments where ad-hoc interactions are required across multiple realms. The KMS1 for a first realm may assert a realm name that is different from a second KMS2 managed realm, and where both are certain a third party has not been assigned a duplicate name. This prevents MITM attacks. The DH exchange may be signed by the name certificate to achieve this goal. The DANE DNS system may be consulted to verify the name assignment and to obtain contextual information that may facilitate the ad-hoc collaboration between KMS hosts. Symmetric keys issued within the context facilitate a common use case scenario where mobile and ad-hoc device-device interactions are expected but where end-to-end security is also expected.

In block 810, a first realm 580-1 obtains a certified realm name R1.

In block 820, realm 580-1 discovers a second realm 580-2.

In block 830, KMS1 510-1 establishes a Diffie-Hellman session with KMS2 510-2.

In block 850, the DH parameters are signed with the R1 and R2 certificates respectively.

In decision block 860, KMS1 510-1 performs a DANE DNS lookup with DANE service 560 to determine whether R1 or R2 are valid. If they are not, then in block 899, the method is done.

In block 870, if R1 or R2 is valid, KMS1 510-1 issues a KMS ticket for D1 in R1 to access D2 in R2.

In block 899, the method is done.

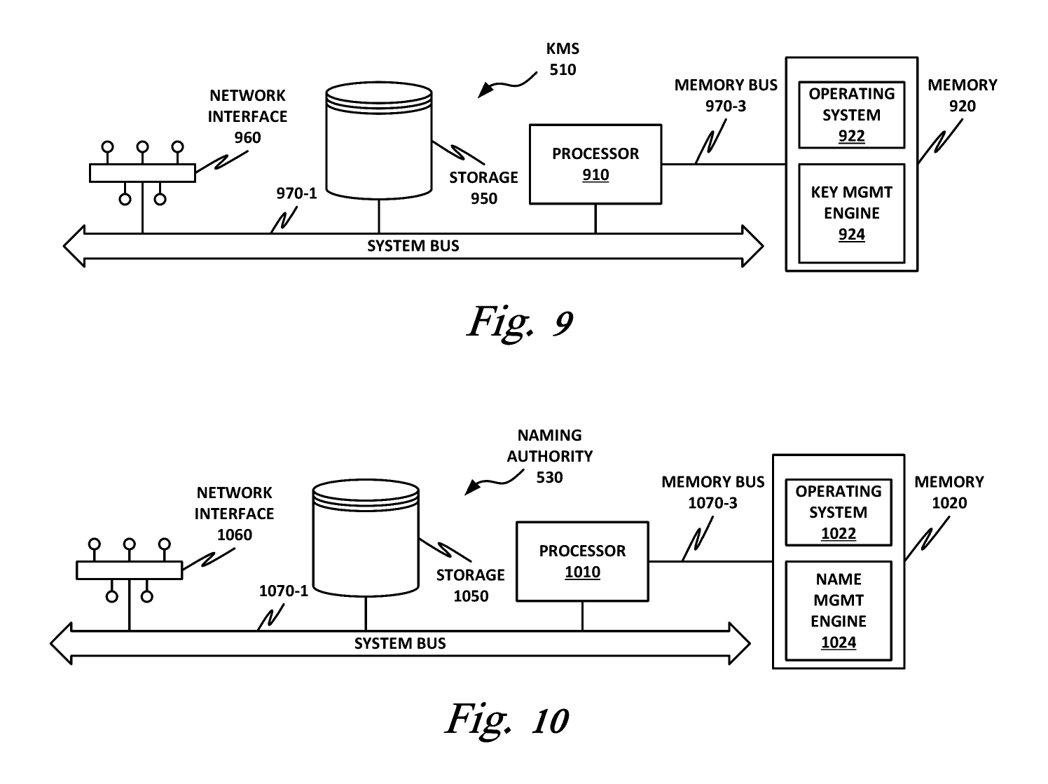

FIG. 9 is a block diagram of a KMS 510 according to one or more examples of the present specification. KMS 510 may be any suitable computing device, as described in connection with FIG. 2. In general, the definitions and examples of FIG. 2 may be considered as equally applicable to FIG. 9, unless specifically stated otherwise.

KMS 510 includes a processor 910 connected to a memory 920, having stored therein executable instructions for providing an operating system 922 and at least software portions of a key management engine 924. Other components of KMS 510 include a storage 950, network interface 960. As described in FIG. 2, each logical block may be provided by one or more similar or dissimilar logic elements.

In an example, processor 910 is communicatively coupled to memory 920 via memory bus 970-3, which may be for example a direct memory access (DMA) bus. Processor 910 may be communicatively coupled to other devices via a system bus 970-1.

Processor 910 may be connected to memory 920 in a DMA configuration via DMA bus 970-3, or via any other suitable memory configuration. As discussed in FIG. 2, memory 920 may include one or more logic elements of any suitable type.

Storage 950 may be any species of memory 920, or may be a separate device, as described in connection with storage 250 of FIG. 2. Storage 950 may be, or may include therein, a database or databases or data stored in other configurations, and may include a stored copy of operational software such as operating system 922 and software portions of key management engine 924.

Network interface 960 may be provided to communicatively couple server 140 to a wired or wireless network, and may include one or more logic elements as described in FIG. 2.

Key management engine 924 is an engine as described in FIG. 2 and, in one example, includes one or more logic elements operable to carry out computer-implemented methods as described in this specification. Software portions of key management engine 924 may run as a daemon process.

Key management engine 924 may include one or more non-transitory computer-readable mediums having stored thereon executable instructions operable to instruct a processor to provide a security engine. At an appropriate time, such as upon booting server 140 or upon a command from operating system 922 or a user or security administrator, processor 910 may retrieve a copy of key management engine 924 (or software portions thereof) from storage 950 and load it into memory 920. Processor 910 may then iteratively execute the instructions of key management engine 924 to provide the desired method. Operationally, key management engine 924 may be configured to collect and classify data provided by data sources 120.

FIG. 10 is a block diagram of a naming authority 530 according to one or more examples of the present specification. Data aggregator 110 may be any suitable computing device, as described in connection with FIG. 2. In general, the definitions and examples of FIG. 2 may be considered as equally applicable to FIG. 10, unless specifically stated otherwise. It should also be noted that the structures disclosed herein may be equally applicable to naming authority 530, name revocation authority 520, and DANE service 560. In certain embodiments, one or more of these features may be provided by a common hardware platform, or by virtual machines running on common hardware.

Data aggregator 110 includes a processor 1010 connected to a memory 1020, having stored therein executable instructions for providing an operating system 1022 and at least software portions of a aggregation engine 1024. Other components of data aggregator 110 include a storage 1050, and network interface 1060. As described in FIG. 2, each logical block may be provided by one or more similar or dissimilar logic elements.

In an example, processor 1010 is communicatively coupled to memory 1020 via memory bus 1070-3, which may be for example a direct memory access (DMA) bus. Processor 1010 may be communicatively coupled to other devices via a system bus 1070-1.

Processor 1010 may be connected to memory 1020 in a DMA configuration via DMA bus 1070-3, or via any other suitable memory configuration. As discussed in FIG. 2, memory 1020 may include one or more logic elements of any suitable type.

Storage 1050 may be any species of memory 1020, or may be a separate device, as described in connection with storage 250 of FIG. 2. Storage 1050 may be, or may include therein, a database or databases or data stored in other configurations, and may include a stored copy of operational software such as operating system 1022 and software portions of aggregation engine 1024.

Network interface 1060 may be provided to communicatively couple server 140 to a wired or wireless network, and may include one or more logic elements as described in FIG. 2.

Name Management Engine 1024 is an engine as described in FIG. 2 and, in one example, includes one or more logic elements operable to carry out computer-implemented methods as described in this specification. Software portions of Name Management Engine 1024 may run as a daemon process.

Name Management Engine 1024 may include one or more non-transitory computer-readable mediums having stored thereon executable instructions operable to instruct a processor to provide a security engine. At an appropriate time, such as upon booting server 140 or upon a command from operating system 1022 or a user or security administrator, processor 1010 may retrieve a copy of Name Management Engine 1024 (or software portions thereof) from storage 1050 and load it into memory 1020. Processor 1010 may then iteratively execute the instructions of Name Management Engine 1024 to provide the desired method. Operationally, Name Management Engine 1024 may be configured to collect and classify data provided by data sources 120.

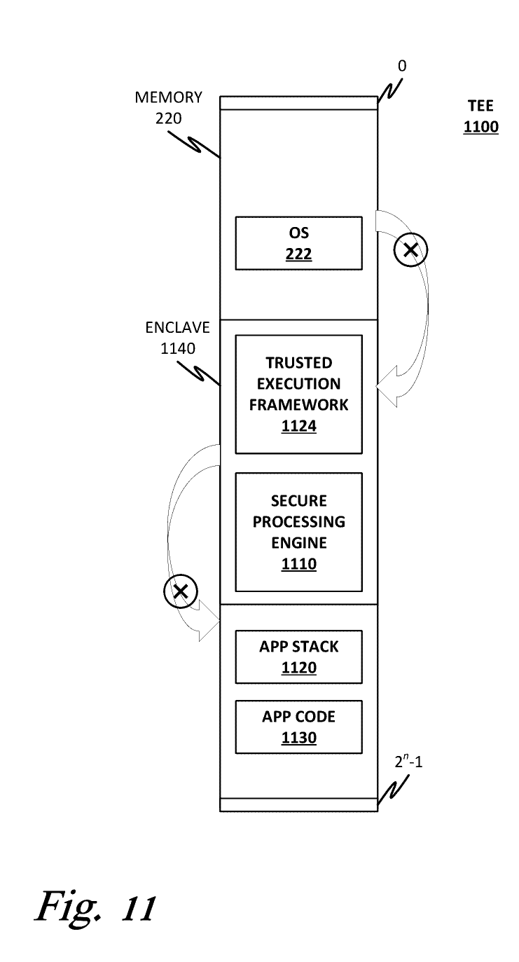

FIG. 11 is a block diagram of a trusted execution environment (TEE) 100 according to one or more examples of the present specification.

In the example of FIG. 11, memory 220 is addressable by n-bits, ranging in address from 0 to 2ⁿ−1. Within memory 220 is an OS 222, enclave 1140, trusted execution framework (TEF) 1124, application stack 1120, and application code 1130.

In this example, enclave 1140 is a specially-designated portion of memory 220 that cannot be entered into or exited from except via special instructions, such as Intel® SGX or similar. Enclave 1140 is provided as an example of a secure environment which, in conjunction with a secure processing engine 1110, forms a trusted execution environment (TEE) 1100. A TEE 1100 is a combination of hardware, software, and/or memory allocation that provides the ability to securely execute instructions without interference from outside processes, in a verifiable way. By way of example, TEE 1100 may include memory enclave 1140 or some other protected memory area, and a secure processing engine 1110, which includes hardware, software, and instructions for accessing and operating on enclave 1140. Non-limiting examples of solutions that either are or that can provide a TEE include Intel® SGX, ARM TrustZone, AMD Platform Security Processor, Kinibi, securiTEE, OP-TEE, TLK, T6, Open TEE, and SierraTEE, CSE, VT-x, MemCore, Canary Island, Docker, and Smack. Thus, it should be noted that in an example, secure processing engine 1110 may be a user-mode application that operates via trusted execution framework 1124 within enclave 1140. TEE 1100 may also conceptually include processor instructions that secure processing engine 1110 and trusted execution framework 1124 require to operate within enclave 1140.

Secure processing engine 1110 and trusted execution framework 1124 may together form a trusted computing base (TCB), which is a set of programs or computational units that are trusted to be secure. Conceptually, it may be advantageous to keep TCB relatively small so that there are fewer attack vectors for malware objects or for negligent software. Thus, for example, operating system 222 may be excluded from TCB, in addition to the regular application stack 1120 and application code 1130.

In certain systems, computing devices equipped with the Intel Software Guard Extension (SGX) or equivalent instructions may be capable of providing an enclave 1140. It should be noted however, that many other examples of TEEs are available, and TEE 1100 is provided only as one example thereof. Other secure environments may include, by way of nonlimiting example, a virtual machine, sandbox, testbed, test machine, or other similar device or method for providing a TEE 1100.

In an example, enclave 1140 provides a protected memory area that cannot be accessed or manipulated by ordinary computer instructions. Enclave 1140 is described with particular reference to an Intel® SGX enclave by way of example, but it is intended that enclave 1140 encompass any secure processing area with suitable properties, regardless of whether it is called an “enclave.”

One feature of an enclave is that once an enclave region 1140 of memory 220 is defined, as illustrated, a program pointer cannot enter or exit enclave 1140 without the use of special enclave instructions or directives, such as those provided by Intel® SGX architecture. For example, SGX processors provide the ENCLU[EENTER], ENCLU[ERESUME], and ENCLU[EEXIT]. These are the only instructions that may legitimately enter into or exit from enclave 1140.

Thus, once enclave 1140 is defined in memory 220, a program executing within enclave 1140 may be safely verified to not operate outside of its bounds. This security feature means that secure processing engine 1110 is verifiably local to enclave 1140. Thus, when an untrusted packet provides its content to be rendered with secure processing engine 1110 of enclave 1140, the result of the rendering is verified as secure.

Enclave 1140 may also digitally sign its output, which provides a verifiable means of ensuring that content has not been tampered with or modified since being rendered by secure processing engine 1110. A digital signature provided by enclave 1140 is unique to enclave 1140 and is unique to the hardware of the device hosting enclave 1140.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise reflected in the appended claims.

### Example Implementations

There is disclosed in one example, a computing apparatus, comprising: a network interface; and one or more logic elements comprising a name management engine, operable to: receive a self-assigned name registration request from a name N1 on an endpoint device via the network interface; compare N1 to a database of registered names; determine that the name has not been registered; and sign a certificate for N1.

There is further disclosed an example, wherein the name management engine is further operable to determine that the name has been registered, and send a notification that the name is not available.

There is further disclosed an example, wherein the name management engine is further operable to determine that the endpoint device has a trusted execution environment (TEE) meeting a minimum security requirement, and wherein the certificate is a high veracity certificate.

There is further disclosed an example, wherein the name management engine is further operable to determine that the endpoint device does not have a trusted execution environment (TEE) meeting a minimum security requirement, and wherein the certificate is a low veracity certificate.

There is further disclosed an example, wherein the name management engine is further operable to determine that the name registration request is signed by a valid signature, and wherein the certificate is a high veracity certificate.

There is further disclosed an example, wherein the valid signature is a proof of possession valid signature.

There is further disclosed an example, wherein the name management engine is further operable to determine that the name registration request is not signed by a valid signature, and wherein the certificate is a low veracity certificate.

There is further disclosed an example, wherein the name management engine is operable to receive a certificate revocation list (CRL).

There is further disclosed an example, wherein receiving the CRL comprises receiving a name revocation request via the network interface.

There is further disclosed an example, wherein the name revocation request is post-dated.

There is further disclosed an example, wherein receiving the CRL comprises receiving a batch CRL via the network interface.

There is further disclosed an example, wherein the name management engine is further operable to mark a plurality of names in the registered name database as revoked, wherein the plurality of names appear on the CRL.

There is further disclosed an example, wherein the CRL is anonymized.

There is further disclosed an example of one or more tangible, non-transitory computer-readable storage mediums having stored thereon executable instructions for instructing one or more processors for providing a name management engine operable for performing any or all of the operations of the preceding examples.

There is further disclosed an example of a method of providing a name management engine comprising performing any or all of the operations of the preceding examples.

There is further disclosed an example of an apparatus comprising means for performing the method.

There is further disclosed an example wherein the means comprise a processor and a memory.

There is further disclosed an example wherein the means comprise one or more tangible, non-transitory computer-readable storage mediums.

There is further disclosed an example wherein the apparatus is a computing device.

There is further disclosed, in an example, a computing apparatus, comprising: a network interface; and a key management engine operable to: determine that a first device D1 in a first realm R1 with the computing apparatus needs to establish a connection with a second device D2 in a second realm R2; establish a secure channel with a secure management service of the second realm R2; and issue a key management ticket for D1 to securely communicate with D2.

There is further disclosed an example, wherein the key management engine is further operable to perform a domain name system (DNS) lookup of a name for R1 or R2 on a DNS-based authentication of named entities (DANE) service.

There is further disclosed an example of one or more tangible, non-transitory computer-readable storage mediums having stored thereon executable instructions for instructing one or more processors for providing a key management engine operable for performing any or all of the operations of the preceding examples.

There is further disclosed an example of a method of providing a key management engine comprising performing any or all of the operations of the preceding examples.

There is further disclosed an example of an apparatus comprising means for performing the method.

There is further disclosed an example wherein the means comprise a processor and a memory.

There is further disclosed an example wherein the means comprise one or more tangible, non-transitory computer-readable storage mediums.

There is further disclosed an example wherein the apparatus is a computing device.

What is claimed is:

1. A computing apparatus, comprising:
a network interface; and
one or more logic elements comprising a name management engine, operable to:
receive a self-assigned name registration request for a name N1 from an endpoint device via the network interface;
compare N1 to a database of registered names;
determine that the name has not been registered; and
sign a certificate for N1.

2. The computing apparatus of claim 1, wherein the name management engine is further operable to determine that the name has been registered, and send a notification that the name is not available.

3. The computing apparatus of claim 1, wherein the name management engine is further operable to determine that the endpoint device has a trusted execution environment (TEE) meeting a minimum security requirement, and wherein the certificate is a high veracity certificate.

4. The computing apparatus of claim 1, wherein the name management engine is further operable to determine that the endpoint device does not have a trusted execution environment (TEE) meeting a minimum security requirement, and wherein the certificate is a low veracity certificate.

5. The computing apparatus of claim 1, wherein the name management engine is further operable to determine that the name registration request is signed by a valid signature, and wherein the certificate is a high veracity certificate.

6. The computing apparatus of claim 5, wherein the valid signature is a proof of possession valid signature.

7. The computing apparatus of claim 1, wherein the name management engine is further operable to determine that the name registration request is not signed by a valid signature, and wherein the certificate is a low veracity certificate.

8. The computing apparatus of claim 1, wherein the name management engine is operable to receive a certificate revocation list (CRL).

9. The computing apparatus of claim 8, wherein receiving the CRL comprises receiving a name revocation request via the network interface.

10. The computing apparatus of claim 9, wherein the name revocation request is post-dated.

11. The computing apparatus of claim 8, wherein receiving the CRL comprises receiving a batch CRL via the network interface.

12. The computing apparatus of claim 8, wherein the name management engine is further operable to mark a plurality of names in the registered name database as revoked, wherein the plurality of names appear on the CRL.

13. The computing apparatus of claim 8, wherein the CRL is anonymized.

14. One or more tangible, non-transitory computer readable storage mediums having stored thereon executable instructions for providing a name management engine, wherein the name management engine is configured to:
receive a self-assigned name registration request for a name N1 from an endpoint device via a network interface;
compare N1 to a database of registered names;
determine that the name has not been registered; and
sign a certificate for N1.

15. The one or more tangible, computer-readable storage mediums of claim 14, wherein the name management engine is further operable to determine that the name has been registered, and send a notification that the name is not available.

16. The one or more tangible, computer-readable storage mediums of claim 14, wherein the name management engine is further operable to determine that the endpoint device has a trusted execution environment (TEE) meeting a minimum security requirement, and wherein the certificate is a high veracity certificate.

17. The one or more tangible, computer-readable storage mediums of claim 14, wherein the name management engine is further operable to determine that the endpoint device does not have a trusted execution environment (TEE) meeting a minimum security requirement, and wherein the certificate is a low veracity certificate.

18. The one or more tangible, computer-readable storage mediums of claim 14, wherein the name management engine is further operable to determine that the name registration request is signed by a valid proof of possession signature, and wherein the certificate is a high veracity certificate.

19. The one or more tangible, computer-readable storage mediums of claim 14, wherein the name management engine is further operable to determine that the name registration request is not signed by a valid signature, and wherein the certificate is a low veracity certificate.

20. The one or more tangible, computer-readable storage mediums of claim 14, wherein the name management engine is operable to receive an anonymized certificate revocation list (CRL).

21. The one or more tangible, computer-readable storage mediums of claim 20, wherein receiving the CRL comprises receiving a name revocation request via the network interface.

22. The one or more tangible, computer-readable storage mediums of claim 21, wherein the name revocation request is post-dated.

23. The one or more tangible, computer-readable storage mediums of claim 20, wherein receiving the CRL comprises receiving a batch CRL via the network interface.

24. A computing apparatus, comprising:
a network interface; and
a key management engine operable to:
determine that a first device D1 in a first realm R1 with the computing apparatus needs to establish a connection with a second device D2 in a second realm R2;
establish a secure channel with a secure management service of the second realm R2; and
issue a key management ticket for D1 to securely communicate with D2.

25. The computing apparatus of claim 24, wherein the key management engine is further operable to perform a domain name system (DNS) lookup of a name for R1 or R2 on a DNS-based authentication of named entities (DANE) service.
